(19) United States
(12) Patent Application Publication
(10) Pub. No.: US 2026/0361255 A1
(43) Pub. Date: Nov. 12, 2026

(54) SMART REDUNDANT LIGHTWEIGHT ACTUATOR

(71) Applicant: Diehl Aerospace GmbH, Ueberlingen (DE)

(72) Inventor: Lothar TRUNK, Weibersbrunn (DE)

(73) Assignee: Diehl Aerospace GmbH, Ueberlingen (DE)

(21) Appl. No.: 19/131,722

(22) PCT Filed: Nov. 8, 2023
(86) PCT No.: PCT/EP2023/081100

§ 371 Date: May 21, 2025

(30) Foreign Application Priority Data
Nov. 23, 2022 (DE) 102022130957.6

(51) Int. Cl. H02P 29/028; B60R 16/023; B60R 16/03; B64D 47/00; H02P 25/22

(52) U.S. Cl. CPC H02P 29/028; B64D 47/00; H02P 25/22; B60R 16/0231; B60R 16/03; B64D 2221/00

(57) ABSTRACT

An actuator (12) for a vehicle (2) having at least two redundant similar vehicle electrical systems (4a,b), which are each provided for full electrical working power (Aa,b) and full powerline communication (PLCa,b), contains an electric drive (16) having supply inputs (24a,b) for the working power (Aa,b) and having similar redundant supply units (26a,b), which comprise a supply output (28a,b) for the full working power (Aa,b) and an electrical-system terminal (14a,b) for the electrical systems (4a,b) for receiving the full working power (Aa,b) and for the full powerline communication (PLCa,b) with the electrical system (4a,b). A vehicle (2) having the electrical systems (4a,b) contains the actuator (12), which is redundantly connected to the electrical systems (4a,b) by means of its electrical-system terminals (4a,b) in order to allow redundant supply with full working power (Aa,b) and to allow redundant full powerline communication (PLCa,b).

The invention relates to an actuator which is intended for use in a vehicle with redundancy requirements, in particular an aircraft.

Full redundancy is required for actuators which are to be used in safety-critical applications, for example in an aircraft.

It is known from practice that two separate actuators are used in safety-critical applications to fulfil a single actuator task. In other words, a second actuator which can fully take over the task of the first actuator if the first actuator fails is installed.

The object of the invention is to propose improvements with regard to the use of actuators in safety-critical applications in vehicles.

This object is achieved by an actuator in accordance with patent claim 1. Preferred or advantageous embodiments of the invention and of other invention categories become apparent from the further claims, from the following description and from the appended figures.

The actuator is used or is designed for a vehicle, that is to say for use in a vehicle. The invention proceeds from a vehicle which has at least two redundant similar on-board electrical systems. “Similar” means that they have, in particular, the same nominal voltages. It also means that both on-board electrical systems are equally adjacent to one another and are used alternatively and equally to supply a consumer which is optionally connected to both on-board electrical systems. This means that the consumer can be operated from each of the redundant electrical systems regularly and permanently in its normal intended operation, in each case completely on its own. Each of the on-board electrical systems is itself designed in each case to provide a full electrical working power for consumers connected to the on-board electrical system, that is to say also the actuator, and to provide full power line communication at or via the on-board electrical system, by means of which connected consumers and thus the actuator can communicate with other remote power line communication stations. Such a remote station is, for example, an avionics system of an aircraft connected via a remote power line communication station. In this case, “full” also means that the working power from each of the electrical systems itself ensures the full equivalent operation of the actuator and its full power line communication. In other words, true full redundancy is ensured here for the actuator from each of the on-board electrical systems.

The actuator contains an electric drive. The electric drive contains at least one, in particular exactly one, supply input. The supply input is used or is designed to supply the drive with an electrical working power which is provided to the drive-from outside the drive-at the supply input.

The actuator contains at least two similar supply units which are of redundant design with respect to one another. In this case, “similar” also means that each of the supply units is fully redundant with respect to the others, thus enabling the full regular operation of the actuator. Each of the supply units has the following characteristics:

The respective supply unit contains at least one, in particular exactly one, supply output. Each of the supply outputs is connected to at least one, in particular exactly one, of the supply inputs and is used to supply the full (in the above sense) working power to said supply input or inputs and thus the drive. In other words, the electric drive is supplied with the regular electrical working power required to perform its tasks via each supply output and supply input. In particular, exactly one of the supply outputs is connected to exactly one of the supply inputs. That is to say the number thereof is the same.

Each of the supply units contains at least one, in particular exactly one, in particular two-pole, electrical system terminal. The electrical system terminal is used or is designed to connect the respective supply unit to at least one, in particular exactly one, of the on-board electrical systems. Each of the electrical system terminals is designed at least to receive the full working power from the on-board electrical system connected as intended. The electrical system terminal is also designed for full power line communication with said or via said on-board electrical system. The electrical system terminal thus fulfils a dual function: On the one hand, to supply the working power to the actuator, on the other hand, to enable/provide power line communication between the actuator and a remote power line communication station which is also located in the on-board electrical system.

Due to the full value of the on-board electrical systems and the redundant supply units with redundant electrical system terminals, the redundancy extends to the actuator, that is to say a consumer. It is ensured that full redundancy exists for the drive in the actuator with regard to the on-board electrical systems. The actuator can-without the use of intermediate distributors or the like as an alternative directly from the redundant on-board electrical systems-be operated fully in regular nominal operation, that is to say unrestricted operation permanently. In other words, the redundancy of the on-board electrical systems extends to the actuator (and in particular even to the drive; see below).

In particular, the supply output is a communication-free output, that is to say an electrical power is available via same, but no processing or execution of communication via the supply output is possible here. This also applies in particular to the supply input. In other words, the entire processing and execution of any communication with the on-board electrical system or a remote station takes place in the supply unit, but not at or in the drive.

According to the invention, it is possible to extend or optimize power line communication in a vehicle with regard to actuators in the safety-critical area. According to the invention, a redundant control unit in the form of the supply unit is integrated in the actuator with a single drive. Said control unit communicates via the power supply, that is to say the on-board electrical system, with a remote station, in particular with the central aircraft control system (avionics system) in an aircraft. The actuator therefore requires in each case only two redundant supply terminals in the form of the electrical system terminals as an interface to the vehicle or aircraft. This results in the following advantages:
Considerable savings in the overall system weight, as two discrete actuators including the mechanical linkage are not required, for example by more than 40%.
Considerable reduction in the overall system complexity.
At least two redundant power supplies (power rails) are supported.
Communication and commanding via the power supply (on-board electrical system/electrical system terminal) significantly reduces the cabling outlay in the vehicle (no separate data lines to the actuators are required).
A large number of actuators can be addressed/controlled via a power supply, for example up to 255.
In particular, a standard power line communication interface is available to communicate with the central avionics system (avionics backbone).
A family concept for actuators is made possible, that is to say actuators of different embodiments etc. can be provided to be connected to one and the same on-board electrical system. This enables different requirements in terms of torque, speed, etc. to be met.
The concept is very maintenance-friendly; individual actuators can be easily replaced (installed, removed), for example in minutes, or simply replaced by alternative actuators where necessary.

The communication of the redundant integrated electronics system in the form of the supply unit via the power supply (on-board electrical system) enables very efficient system design and very simple expandability. According to the invention, a “smart redundant lightweight actuator (SRLA)” is obtained. This results in a smart redundant lightweight actuator. Said actuator is integrated, including the necessary redundant electronics system (supply unit), in particular within an actuator housing. The actuator is controlled by means of data/signal transmission via the supply line, that is to say power line communication.

Applications for actuators include flaps and rudder control, door control, pump control, rotor head control. Communication in the vehicle can be standardized. Maintenance is simplified. The solution does not depend on a specific avionics system, and so it can be used with different generations of avionics (generally vehicle control system). The solution can be used in the field of retrofitting.

In a preferred embodiment, the drive—as already indicated above—has exactly one supply input per supply unit. This creates redundancy in the actuator from the electrical system terminal to the respective supply input of the drive, such that only a failure of the drive itself leads to the failure of the actuator. All other supply of/actuation of/communication with the drive in the actuator is then redundant.

In a preferred embodiment, the drive contains at least two supply inputs. Proceeding from the two supply inputs, the drive itself is partially or partly redundant. The redundant parts are redundancy sections of the drive. These lead to a remaining part of the drive which is not of redundant design. Thus, the drive itself is of at least partially redundant construction with regard to the supply units. Thus, the redundancy of the supply units is extended or expanded “to the drive”. Even a partial failure or partial defect in the redundant part of the drive itself does not have to lead to the failure of the drive and thus of the actuator. The joint or non-redundant part of the drive together with a respective one of the redundancy sections forms a full drive. As a result, the drive thus has a non-redundant part which is supplied by the redundant redundancy sections, interacts with them, etc., with each of the redundancy sections having at least one of the supply inputs.

In a preferred variant of this embodiment, the drive contains at least one, in particular exactly one, movable output part. This is, for example, a rotor of a rotary motor or a slide of a linear motor, etc. At least two, in particular all, of the redundancy sections then each contain a redundant stator part, wherein at least two of the stator parts act on the same output part. The drive therefore contains at least two stator parts. At least two of the stator parts are designed or configured to act on the same drive part. Each stator part together with the assigned drive part is designed to work independently as at least part of the drive, in particular as a complete drive, that is to say to completely fulfil the drive functionality, that is to say to independently fulfil the full drive functionality. In other words, the drive works fully as intended, as long as the output parts and each one of the stator parts work together as intended. This ensures a particularly high level of redundancy in the drive as well.

In a preferred variant of this embodiment, each of the stator parts has exactly one of the supply inputs. This results in a particularly simple, but completely redundant actuator for each stator section.

In a preferred variant of this embodiment, in particular, the drive contains an electric motor and each of the stator parts contains a separate stator winding of the motor. This means that the stator winding is self-contained and is formed independently of or separate from other stator windings. The corresponding stator winding together with the output part thus fulfils the overall drive functionality. In particular, the drive part is a rotor or a linear slide with a permanent magnet or (rotor) winding.

In a preferred embodiment, at least one of the supply units is designed as follows: It contains a power module connected to the electrical system terminal and supplied with the working power during operation. Said power module is set up to receive the working power from the on-board electrical system. However, it does not have the ability for power line communication, but has the power output. In other words, the power module is designed solely to supply power to the drive from the on-board electrical system, but not for power line communication with the on-board electrical system. The supply unit also contains a communication module connected to the electrical system terminal. Said communication module is designed for power line communication with the on-board electrical system, but not for receiving the working power from the on-board electrical system. In other words, the communication module only performs a communication task, but it is not used to transmit the working power from the on-board electrical system to the drive. Thus, each module can be optimized for its task. Sensor information can also be supplied to the outside via the communication module, for example; see below.

In a preferred variant of this embodiment, at least one of those supply units containing a power module also contains a control module. The control module is designed to actuate the drive with regard to its operation by actuating the power module on the basis of power line communication. In other words, the control module controls the actual drive functionality of the drive, switching it on or off, for example, depending on which commands/signals/values are delivered via the power line communication. In addition, for example, sensor information is processed in the control module; see below.

In a preferred embodiment, at least one of the supply units contains at least one sensor module. Said sensor module is used or is configured to determine sensor information at the actuator. “At the actuator” includes information inside and/or outside the actuator, for example in the surroundings thereof. For example, a motor position of a rotor/linear slide or an ambient temperature outside the actuator can be determined and processed inside the actuator or communicated outside the actuator. Additional sensor modules can detect, for example, temperatures, vibrations, wear, mechanical stress, etc. In particular, sensor information can be used internally in the actuator, for example for speed control/regulation of the drive, etc. In this case, too, the control module can be optimized for its task. The actuator is then designed for internally processing and/or forwarding the sensor information to the power line communication.

In a preferred embodiment, the actuator has only one single connector per electrical system terminal as electrical terminals. In particular, the actuator has no other wired or wireless electrical interfaces, including communication and power interfaces as well. The only electrical power supply and communication thus takes place via the plug-in connector. In particular, the plug-in connector is a single plug-in contact/plug/socket. As an alternative, the plug-in connector can also be designed as a plug/socket assembly.

This object is also achieved by a vehicle in accordance with patent claim 11. The vehicle has the aforementioned at least two redundant similar on-board electrical systems. Each of the on-board electrical systems is designed in each case to provide both full electrical working power and full power line communication for an actuator, as described above. The vehicle contains at least one actuator according to the invention. Said actuator is connected by means of at least two of its electrical system terminals to at least two of the on-board electrical systems in such a way that a respective or redundant supply with the full working power and respective or redundant full power line communication is possible via the at least two of the electrical system terminals from the at least two of the on-board electrical systems. In other words, the actuator is thus connected fully redundantly to the at least two on-board electrical systems, wherein an independent supply of working power and independent power line communication is possible via each of the two on-board electrical systems. In particular, multiple actuators are connected to the on-board electrical system. In particular, in this case, each of the actuators is clearly addressed with regard to its power line communication, such that each actuator can communicate individually and thus can also be operated, actuated, etc. individually.

The vehicle and at least some of the embodiments thereof and the respective advantages have already been explained analogously in connection with the actuator according to the invention.

In a preferred embodiment, the vehicle is an aircraft. In particular for aircraft, the aforementioned advantages of the invention have a particularly serious effect.

Further features, effects and advantages of the invention are obtained from the following description of a preferred exemplary embodiment of the invention and the accompanying figures. In this case, in each case in a basic schematic diagram:

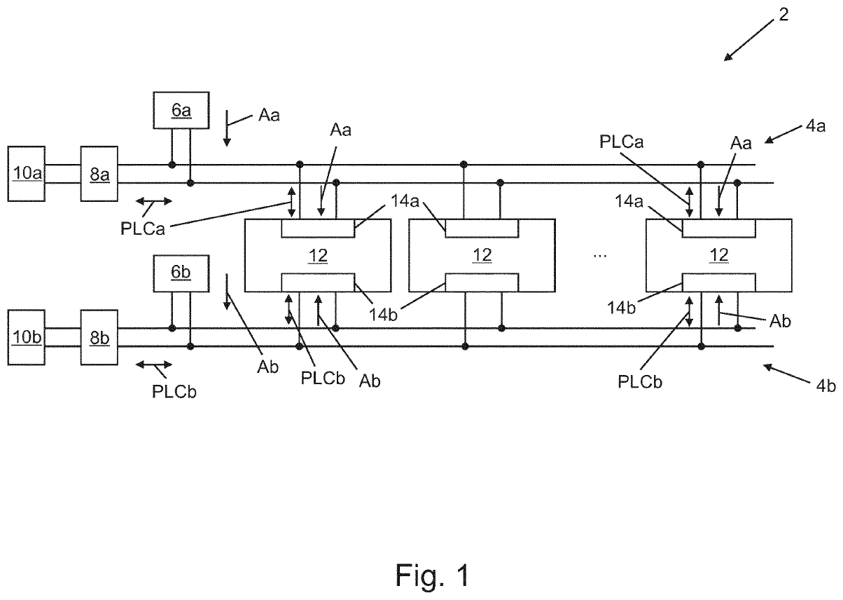

FIG. 1 shows a block diagram of a vehicle having two on-board electrical systems and actuators,

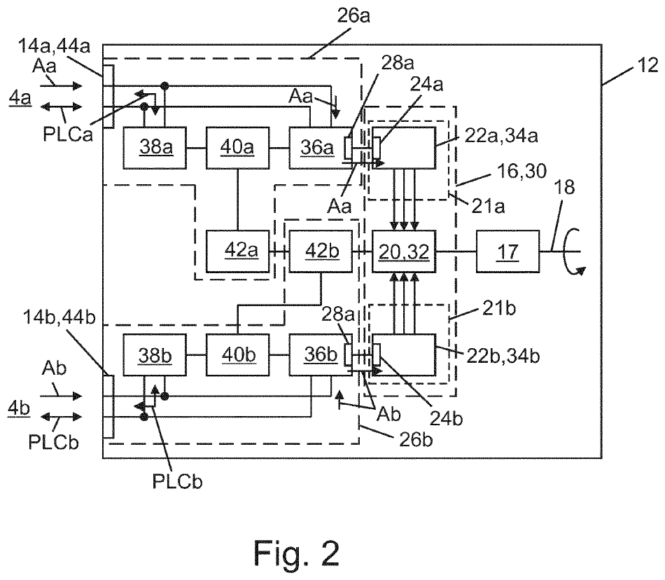

FIG. 2 shows a block diagram of one of the actuators from FIG. 1.

FIG. 1 shows a section of a vehicle 2, in this case an aircraft in the form of a passenger aircraft. The vehicle 2 has two redundant on-board electrical systems 4a,b, each of which is designed with two wires in this case. Each of the on-board electrical systems 4a,b is supplied with electrical power from a respective power supply 6a,b, in this case an electrical on-board generator. A respective power line communication unit 8a,b is connected to each on-board electrical system 4a,b, which unit in turn is communicatively connected to each avionics system 10a,b of the aircraft. Thus, on each of the on-board electrical systems 4a,b, an electrical working power Aa,b from the power supply 6a,b and power line communication PLCa,b with or to the power line communication unit 8a,b or avionic system 10a,b is available redundantly for any consumers to be connected. Both are symbolically indicated in the figure by arrows.

In the example, a total of 255 actuators 12 are connected to the on-board electrical systems 4a,b, of which only three are shown by way of example in FIG. 1. Each of the actuators 12 is redundantly connected to both on-board electrical systems 4a,b by means of a respective electrical system terminal 14a,b. The respective electrical system terminals 14a are connected to the on-board electrical system 4a; the respective electrical system terminals 14b are connected to the on-board electrical system 4b. Thus, the relevant actuator 12 is supplied with working power Aa via an electrical system terminal 14a and enables power line communication PLCa with the on-board electrical system 4a. Each of the terminals 14b enables a corresponding working power Ab to be drawn from the on-board electrical system 4b and enables communication PLCb with the on-board electrical system 4b.

FIG. 2 shows an example of one of the actuators 12 from FIG. 1. Each of the actuators 12 contains a drive 16, in this case a motor 30 in the form of an electric rotary motor. Said motor contains an output part 20 in the form of a rotor, which can be rotated about an axis of rotation 18, as well as two redundant stator parts 22a,b, as will be explained in more detail below. The electric drive 16 has two redundant supply inputs 24a,b. The supply inputs 24a,b are each used to either redundantly or exclusively supply the drive 16 with drive power Aa or Ab. In the example, a gear mechanism 17, which is not explained in any more detail, is connected downstream of the drive 16. The rotation about the axis of rotation 18 during operation is indicated by arrows.

The actuator 12 also contains two supply units 26a,b which are also redundant with respect to one another. Each of the supply units 26a,b has a supply output 28a,b. Said supply outputs are connected 1 to 1 to the supply inputs 24a,b in order to supply same. In addition, the supply units 26a,b have the respective electrical system terminals 14a,b explained above. The electrical system terminals 14a,b are thus each designed to receive working power Aa,b from the on-board electrical systems 4a,b and for power line communication PLCa, b with the on-board electrical systems 4a,b. The drive 16 thus has exactly one supply input 24a,b per supply unit 26a,b.

The drive 16 itself is also of at least partially redundant construction with regard to the supply units 26a,b. This is achieved by the fact that the drive 16 contains two redundancy sections 21a,b. Furthermore, it contains a single non-redundant movable drive part 20, but has two redundant stator parts 22a,b as parts of the redundancy sections 21a,b. Each of the redundancy sections 21a,b also has one of the supply inputs 24a,b. Each of the redundancy sections 21a,b or each of the stator parts 2a,b together with the output part 20 is designed to fulfil the full drive functionality of the drive 16. In other words, a single redundancy section 21a,b or stator part 22a or 22b together with the output part 20 is sufficient to deploy the full drive power of the drive 16, in this case of the motor. This means that, even if the stator part 22a or the stator part 22b fails, the drive 16 can fulfil its drive functionality (drive of the axis of rotation 18) fully as intended. Each of the stator parts 22a,b has exactly one of the supply inputs 24a, b. The drive 16 is in this case the motor 30, the output part 20, a rotor 32 and each of the stator parts 22a,b contains a stator winding 34a,b.

Each of the supply units 26a,b contains a power module 36a,b supplied by the respective electrical system terminal 14a,b or connected thereto. Said power module is designed to receive the respective working power Aa, b from the on-board electrical system 4a,b, but has no capability for power line communication PLCa, b and has the respective supply output 28a,b.

Each of the supply units 26a,b also contains a communication module 38a,b communicatively connected to the electrical system terminal 14a,b. Said communication module is designed for power line communication PLCa, b with the respective on-board electrical system 4a,b, but not for receiving/directing the respective working power Aa,b. Each of the supply units 26a,b also contains a control module 40a,b. Said control module is connected to the power modules 36a,b and communication modules 38a,b and is designed to control the drive 16 by actuating the respective power module 36a,b with regard to its operation on the basis of the power line communication PLCa, b. The supply units 26a,b also each contain a sensor module 42a,b, in this case a respective motor position sensor which is of redundant design and which is coupled to the axis of rotation 18 or shaft of the rotor 32. Each of the sensor modules 42a,b is also connected to the control module 40a,b and is used to determine a respective piece of sensor information at the actuator 12. A current rotation angle of the axis of rotation 18 is determined here. In addition, the sensor modules 42a,b are used for forwarding the relevant sensor information to the power line communication PLCa, b, in this case by connection to the control modules 40a,b. In the control modules 40a,b, the motor position can be used internally to operate the drive 16, for example for speed regulation or for the determination of a specific current rotational position. However, the sensor information can also be transmitted to the power line communication PLCa, b via the on-board electrical networks 4a,b to the respective avionics system 10a,b, such that it is also available outside the actuator 12.

The electrical system terminals 14a,b are each designed in this case as the only plug-in contacts 44a,b. The plug-in contacts 44a,b represent the only electrical terminals of the actuator 12. The actuator 12 thus has no other wired or wireless electrical interfaces.

### LIST OF REFERENCE SIGNS

2 Vehicle
4a,b On-board electrical system
6a,b Power supply
8a,b Power line communication unit
10a,b Avionics system
12 Actuator
14a,b Electrical system terminal
16 Drive
17 Gear mechanism
18 Axis of rotation
20 Output part
21a,b Redundancy section
22a,b Stator part
24a,b Supply input
26a,b Supply unit
28a,b Supply output
30 Motor
32 Rotor
34a,b Stator winding
36a,b Power module
38a,b Communication module
40a,b Control module
42a,b Sensor module
44a,b Plug-in contact
Aa,b Working power
PLCa,b Power line communication

1. An actuator for a vehicle having at least two redundant similar on-board electrical systems, wherein each of the on-board electrical systems is designed to provide both a full electrical working power, which itself ensures the full equivalent operation of the actuator, and full power line communication, which itself ensures the full equivalent operation of the actuator, for the actuator,
having a single electric drive having at least one supply input for supplying electrical working power to the drive,
having at least two similar redundant supply units, wherein each of the supply units has:
a supply output connected to at least one of the supply inputs for supplying the full working power to at least one of the supply inputs, and
an electrical system terminal for connecting the supply unit to at least one of the on-board electrical systems,
wherein the electrical system terminal is at least designed to receive the full working power from the on-board electrical system and for full power line communication with the on-board electrical system.

2. The actuator as claimed in claim 1,
wherein the drive has exactly one supply input per supply unit.

3. The actuator as claimed in claim 1,
wherein the drive contains at least two supply inputs and, starting from the supply inputs, the drive is of at least partly redundant construction in the form of a respective redundancy section.

4. The actuator as claimed in claim 3,
wherein the drive contains at least one movable output part and at least two of the redundancy sections in each case contains a redundant stator part for acting on the same output part, wherein each stator part with the assigned output part is designed to independently fulfil the full drive functionality of the drive.

5. The actuator as claimed in claim 4,
wherein
each of the stator parts has exactly one of the supply inputs.

6. The actuator as claimed in claim 4, wherein
the drive contains a motor and each of the stator parts contains a separate stator winding of the motor.

7. The actuator as claimed in claim 1 wherein
at least one of the supply units contains:
a power module which is supplied by the electrical system terminal and designed to receive the working power from the on-board electrical system, but which has no capability for power line communication and has the supply output, and
a communication module which is connected to the electrical system terminal and designed for power line communication with the on-board electrical system, but which is not designed to receive the working power from the on-board electrical system.

8. The actuator as claimed in claim 7,
wherein
at least one of the supply units with the power module contains a control module which is designed to control the drive by actuating the power module with regard to its operation on the basis of power line communication.

9. The actuator as claimed in claim 1, wherein
at least one of the supply units contains at least one sensor module which is designed to determine a piece of sensor information at the actuator.

10. The actuator as claimed in claim 1, wherein
the actuator has only one plug-in contact per electrical system connection as electrical terminals.

11. A vehicle having at least two redundant similar on-board electrical systems, wherein each of the on-board electrical systems is designed to provide both a full electrical working power, which itself ensures the full equivalent operation of the actuator, and full power line communication, which itself ensures the full equivalent operation of the actuator, for an actuator, having at least one actuator as claimed in claim 1, which is connected to at least two of the on-board electrical systems by means of at least two of its electrical system terminals in such a way that a redundant supply with the full working power is possible via the at least two of the electrical system terminals and fully redundant power line communication with the at least two of the on-board electrical systems is possible.

12. The vehicle as claimed in claim 11,
wherein
the vehicle is an aircraft.

13. The actuator as claimed in claim 5, wherein the drive contains a motor and each of the stator parts contains a separate stator winding of the motor.
